(19) United States
(12) Patent Application Publication
(10) Pub. No.: US 2007/0048566 A1
(43) Pub. Date: Mar. 1, 2007

(54) Fuel cell unit, control method for fuel cell unit, and information processing apparatus

(76) Inventors: Koji Nakamura, Tokyo (JP); Akihiro Ozeki, Tokyo (JP); Ryoji Ninomiya, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/509,008

(22) Filed: Aug. 24, 2006

Related U.S. Application Data
(63) Continuation of application No. PCT/JP05/03692, filed on Feb. 25, 2005.

(30) Foreign Application Priority Data
Feb. 27, 2004 (JP) P2004-54879

(51) Int. Cl. H01M 8/04

(52) U.S. Cl. 429/22; 429/13; 429/23

(57) ABSTRACT

A fuel cell unit according to the invention, includes a connection portion used for establishing the connection with an external apparatus, a fuel cell for generating power to be supplied to the external apparatus via the connection portion; auxiliary sections for feeding air and fuel to the fuel cell, and a controller for controlling the auxiliary sections and performing refresh processing to improve power generation efficiency of the power generator. The fuel cell unit can avoid reduction in power generation capability and maintain a constant power generation capability.

### CROSS-REFERENCE TO RELATED APPLICATION

This application is based upon and claims the benefit of priority from PCT Application No. PCT/JP2005/003692 filed Feb. 25, 2005 and Japanese Patent Application No. 2004-54879, filed Feb. 27, 2004, the entire contents of which are incorporated herein by reference.

### BACKGROUND

1. Field

The present invention relates to fuel cell units, control methods for fuel cell units, and information processing apparatuses. In particular, the present invention relates to a fuel cell unit for performing refresh processing, a method for controlling the fuel cell unit and an information processing apparatus connected with the fuel cell unit.

2. Description of the related Art

Currently, for example, lithium-ion batteries are used as secondary batteries, which are one type of power supply sources, for information processing apparatuses. One feature of the secondary batteries is that they can be repeatedly used upon being charged with, for example, a commercial power supply, as opposed to disposable primary batteries.

The lithium-ion batteries, however, requires a commercial power supply for charging, since they are secondary batteries.

In conjunction with remarkable improvements in the features and performance of information processing apparatuses in recent years, the power consumption of the information processing apparatuses are also on an upward trend. Thus, it is desired that the density of energy, i.e., the amount of energy output per unit volume or unit mass, provided by lithium ion batteries that supply power to the information processing apparatuses is increased. It is, however, difficult to expect a remarkable increase under the current situation.

In theory, the energy density of a fuel cell is said to be ten times as much as that of a lithium ion battery (for example, refer to “Fuel Cell 2004 (Nenryou-Denchi 2004)” Nikkei Business Publications, Inc., pp. 49-50 and pp. 64, October 2003, hereinafter referred to as Non Patent Document 1). This indicates that, when the fuel cell has the same volume or mass as the lithium battery, the fuel cell has the potential to supply power for a (e.g., ten times) longer period of time. Further, that also indicates that, when both have the same power-supply time, the fuel cell has the potential to be reduced in size and weight as compared to the lithium ion battery.

Further, with a fuel cell, fuel such as methanol can be encapsulated into a small container, and the replacement of the small package as a unit can eliminate the need for charging that uses an external power-supply. Thus, compared to a case a lithium-ion battery is used to supply power to an information processing apparatus at a place where no AC power-supply facility is available, the use of a fuel cell allows the information processing apparatus to operate for a long period.

Additionally, when an information processing apparatus (e.g., a notebook personal computer) using a lithium-ion battery is used for a long period of time, it is difficult for the information processing apparatus to operate on power supplied from the lithium-ion battery for a long period of time. Consequently, the use of the information processing apparatus is limited to an environment where power supply with an AC power-supply is available. In contrast, the use of a fuel cell to supply power to the information processing apparatus allows the information processing apparatus to operate for a longer period of time, compared to the case of using a lithium-ion battery, and can also provide the advantage of eliminating the above-noted limitation.

In view of the foregoing situation, fuel cells aimed to supply power to information processing apparatuses are under research and development. For example, relevant technologies are disclosed in Japanese Patent Application Publication (KOKAI) No. 2003-142137, Japanese Patent Application Publication (KOKAI) No. 2003-86192, and Japanese Patent Application Publication (KOKAI) No. 2002-169629.

Various types of fuel cell systems are available (e.g., refer to “Everything of Fuel Cell (Nenryoudenchi-no-subete),” Hironosuke Ikeda, Nippon Jitsugyo Publishing Co., Ltd., August 2001, hereinafter referred to as Non Patent Document 2) However, when compactness, lightweight, and the ease of handling of the fuel cell are considered, for example, a direct methanol fuel cell (DMFC) is suitable for information processing apparatuses. This fuel cell system uses methanol as a fuel and the methanol is directly introduced into a fuel cell electrode without being converted into hydrogen.

For the direct methanol fuel cell, the concentration of methanol introduced into the fuel electrode is important. A high concentration leads to decreased power generation efficiency, which makes it impossible to provide satisfactory performance. This is due to a phenomenon (called a crossover phenomenon) in which part of methanol, which is used as a fuel, passes through an electrolyte membrane (specifically, a solid polymer electrolyte membrane) sandwiched between the fuel electrode (a negative electrode) and an air electrode (a positive electrode). The crossover phenomenon becomes more pronounced for high-concentration methanol and is attenuated when low-concentration methanol is introduced into the fuel electrode.

On the other hand, when low-concentration methanol is used as a fuel, high performance can readily be ensured but the volume of the fuel is increased (e.g., by a factor of ten) compared to a case in which high-concentration methanol is used. Thus, the fuel container (i.e., the fuel cartridge) becomes large.

Accordingly, miniaturization can be achieved by encapsulating high-concentration methanol into the fuel cartridge. In addition, the crossover phenomenon can be reduced by causing small pumps, values, and so on to circulate water produced during power generation and reducing the concentration of the high-concentration methanol by dilution before the methanol is introduced into the fuel electrode. This system can also improve the power generation efficiency. Hereinafter, those pumps, valves, and so on for circulation will be referred to as “auxiliary sections” and such a system for circulation will be referred to as a “dilution circulation system”.

Such an approach (as disclosed in Non Patent Document 1) can achieve a compact, lightweight fuel-cell unit having high power-generation efficiency.

Before problems to be solved by the invention are described, the principle of operation of a fuel cell will be briefly described first. Since the principle of operation is already described in detail in known documents (e.g., Non Patent Document 1 mentioned above), an overview of the principle will now be described.

FIG. 1 illustrates the principle of operation of a direct methanol fuel cell (DMFC) 5. In the DMFC 5, an electrolyte membrane 1 is arranged at the center and is sandwiched by a fuel electrode (a negative electrode) 2 and an air electrode (a positive electrode) 3 from two opposite sides.

When a methanol-water solution is introduced into one end of the fuel electrode 2 of the DMFC 5, oxidation reaction of methanol occurs at the fuel electrode 2. As a result, electrons (e⁻), hydrogen ions (H⁺), and carbon dioxide (CO₂) are generated. The hydrogen ions (H⁺) pass through the electrolyte membrane 1 to reach the air electrode 3. The carbon dioxide (CO₂) is exhausted from another end of the fuel electrode 2.

The electrons (e⁻) circulate from the fuel electrode 2 to the air electrode 3 via a load 4. The flow of the electrons enables power to be supplied to an external apparatus. At the air electrode 3, oxygen (O₂) in the air that is externally introduced reacts with the hydrogen ions (H⁺) that has passed through the electrolyte membrane 1 and the electrons (e⁻) that have circulated via the load 4, so that water H₂O (water vapor) is produced.

FIG. 1 illustrates only one unit of the fuel cell structure, and, in practice, a plurality of DMFCs 5 are stacked to provide a predetermined voltage and current. The stack of the DMFCs 5 is called a “DMFC stack”.

In the process of power generation of the fuel cell, carbon oxide (CO₂) occurs as one of reaction products in the fuel electrode 2. This carbon oxide is discharged from the other end of the fuel cell 2 together with the methanol/water solution unused in the reaction.

Only a part of the carbon dioxide, however, adheres to the fuel electrode 2 in bubbles, so that the reaction area of the fuel electrode 2 decreases and thereby a reduction in the power generation capability may be caused.

On the other hand, in the air electrode 3, water (H₂O) as a reaction product occurs in the form of water vapor. This water vapor is recovered as liquid phase water, and used for diluting high-concentration methanol. Here also, however, part of water vapor adheres to the air electrode 3 as water drops, so that the reaction area of the air electrode 3 decreases and thereby a reduction in the power generation capability may be caused.

In order eliminate such factors responsible for the reduction in power generation, a special processing referred to as “refresh processing” is usually tried. Specifically, the refresh processing is processing in which, during a predetermined time period, bubbles and water drops adhering to the fuel electrode 2 and the air electrode 3, respectively, are forcedly discharged and removed by injecting a methanol/water solution and air into the fuel electrode 2 and the air electrode 3, respectively, in a manner different from that in the ordinary power generation, for example, by using a stronger pressure.

A state of a fuel cell unit that is in the process of being performing refresh processing is referred to as a “refresh state”. The refresh processing enables the avoidance of the reduction in power generation capability and the maintenance of a constant power generation capability.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram explaining the operation principle of a fuel cell (DMFC);

FIG. 2 is an external view of an embodiment of a fuel cell unit according to the present invention;

FIG. 3 is an external view showing a state where an embodiment of an information processing apparatus according to the present invention is connected to the fuel cell unit shown in FIG. 2;

FIG. 4 is a schematic diagram chiefly showing the power generator of the fuel cell unit;

FIG. 5 is a schematic diagram showing the state where the information processing apparatus shown in FIG. 3 is connected to the fuel cell unit;

FIG. 6 is a schematic diagram explaining the fuel cell unit and a first embodiment of the information processing apparatus;

FIG. 7 is a state transition diagram of the fuel cell unit according to the present invention;

FIG. 8 is a table showing main control commands with respect to the fuel cell unit according to the present invention;

FIG. 9 is a table showing main power-supply information on the fuel cell unit according to the present invention;

FIG. 10 is a flowchart showing refresh processing in the present invention; and

FIG. 11 is a flowchart showing the prohibition and permission with respect to the transfer to refresh processing.

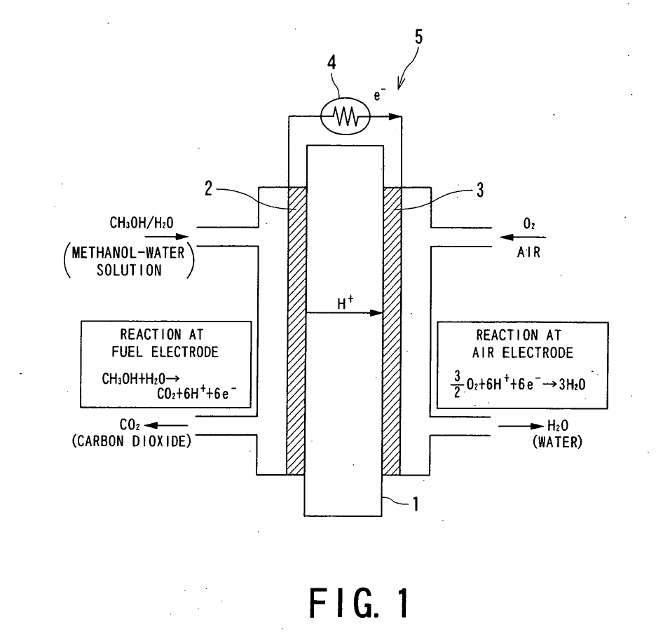

### DETAILED DESCRIPTION

A fuel cell unit, a control method therefor, and an information processing apparatus according to embodiments of the present invention will now be described with reference to the accompanying drawings.

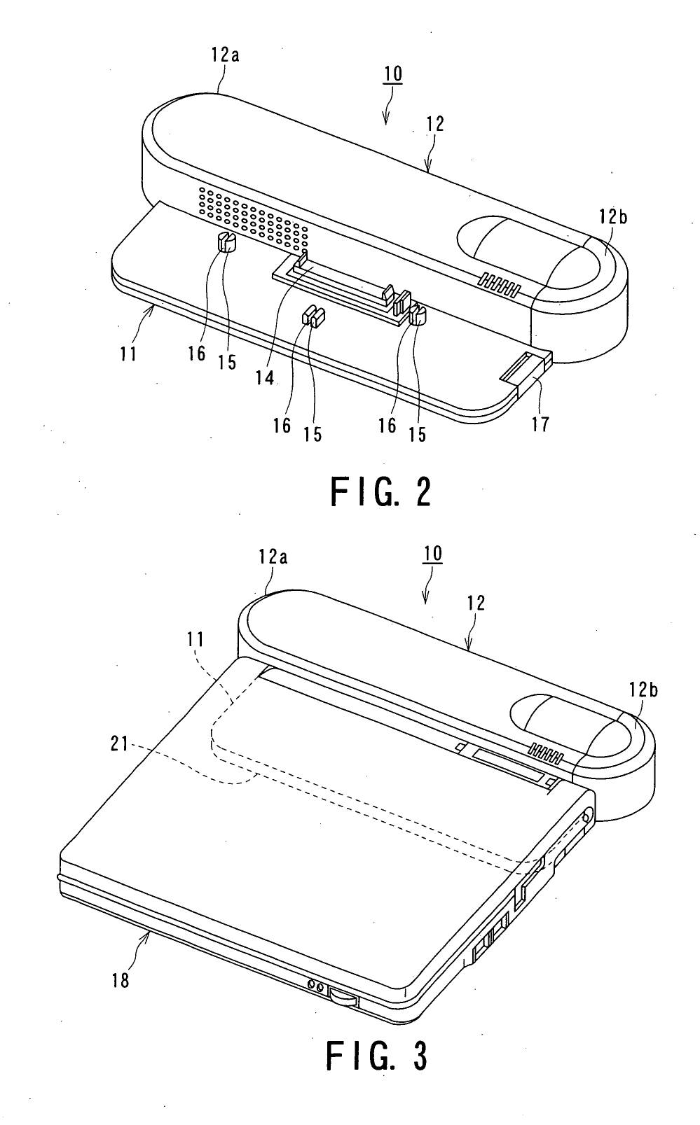

FIG. 2 is an external view of an first embodiment of a fuel cell unit according to the present invention. Referring to FIG. 2, the fuel cell unit 10 comprises a mounting section 11 for mounting the rear part of an information processing apparatus such as a notebook personal computer, and a fuel cell unit body 12. The fuel cell unit body 12 incorporates a DMFC stack generating power based on an electrochemical reaction, and auxiliary sections (pumps, valves and the like) for injecting and circulating methanol serving as fuel with respect to the DMFC stack, and air.

Within a unit case 12a of the fuel cell unit body 12, and for example, at the right end in FIG. 2, a detachable fuel cartridge (not shown) is incorporated. A cover 12b is removably provided so that the fuel cartridge can be replaced.

An information processing apparatus is mounted on the mounting section 11. On the top surface of the mounting section 11, there is provided a docking connector 14 serving as a connection portion for establishing connection with the information processing apparatus 18 shown in FIG. 3. On the other hand, for example, on the rear bottom surface of the information processing apparatus 18, there is provided a docking connector 21 (not shown) serving as a connection portion for establishing connection with the fuel cell unit 10, and it is mechanically and electrically connected with the docking connector 14 of the fuel cell unit 10. Sets of positioning projections 15 and hooks 16 are each provided at three positions on the mounting section 11, and these sets of positioning projections 15 and hooks 16 are inserted into corresponding three holes provided in the rear bottom surface of the information processing apparatus 18.

When attempting to detach the information processing apparatus 18 from the fuel cell unit 10, an eject button 17 in the fuel cell unit 10 shown in FIG. 2 is pushed, whereby a locking mechanism (not shown) is released and allows the fuel cell unit 10 to be easily detached.

FIG. 3 is an external view showing a state where the information processing apparatus 18, such as a notebook personal computer, is mounted on and connected to the mounting section 11 of the fuel cell unit 10.

Possible shapes and sizes of the fuel cell unit 10, and possible shapes and locations of the docking connector 14 shown in FIGS. 2 and 3 include a variety of kinds.

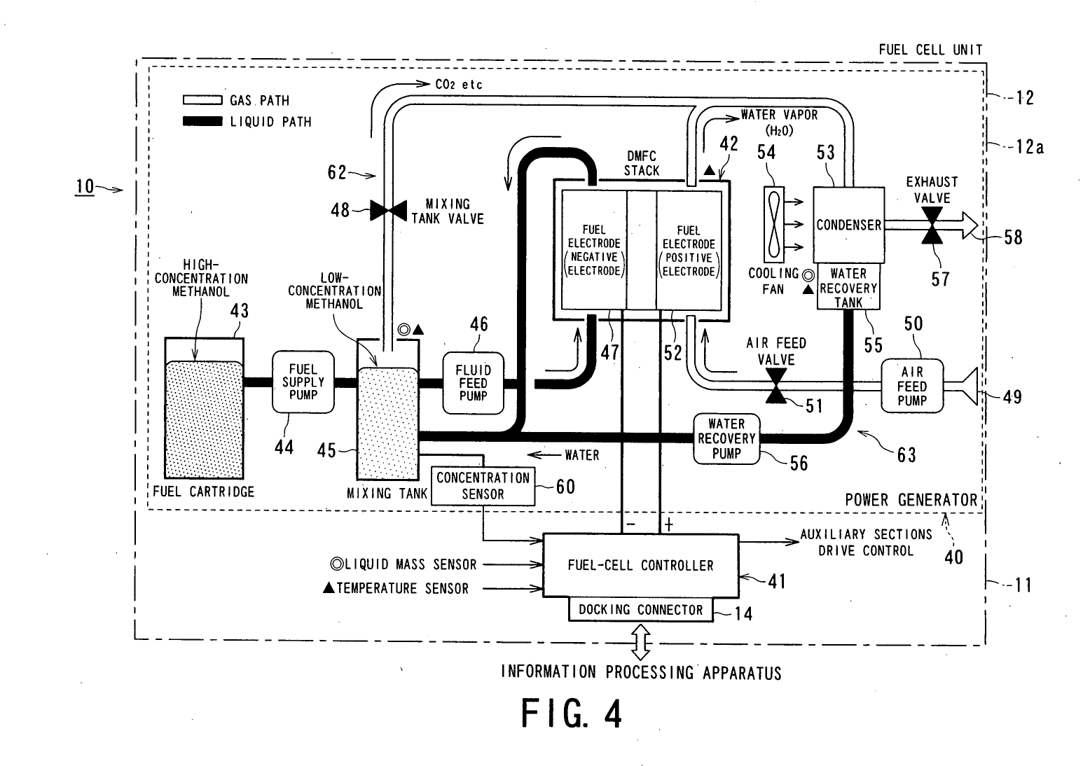

Next, the construction of the fuel cell unit 10 according to the present invention will be explained. In particular, the DMFC stack and auxiliary sections provided therearound will be described in detail with reference to a schematic diagram shown in FIG. 4.

The fuel cell unit 10 includes a power generator 40 and a fuel cell controller 41 functioning as a controller of the fuel cell unit 10. The fuel cell controller 41 performs the control with respect to the power generator 40 and has the function of communicating with the information processing apparatus 18.

The power generator 40 has a DMFC stack 42 playing a predominant role in performing power generation, and a fuel cartridge 43 for accommodating methanol serving as fuel. High-concentration methanol is sealed in the fuel cartridge 43. The fuel cartridge 43 is removably formed so as to be easily replaceable when it runs out of fuel.

In the direct methanol fuel cell, it is necessary to reduce the crossover phenomenon to enhance the power generation efficiency. An effective method serving this purpose is to dilute high-concentration methanol to a low concentration and inject it into the fuel electrodes 47. To implement this method, the fuel cell unit 10 adopts a dilution circulation system 62, which is arranged in the power generator 40. The dilution circulation system 62 is implemented by auxiliary sections 63 comprising a plurality of constituent components.

As shown in FIG. 4, the auxiliary sections 63 are constructed by pipe-connecting a fuel supply pump 44, mixing tank 45, fluid feed pump 46, mixing tank valve 48, air feed pump 50, air feed valve 51, condenser 53, cooling fan 54, water recovery tank 55, water recovery pump 56, exhaust valve 57, and the like, which are installed in liquid paths through which a methanol/water solution, water and the like are circulated, and in gas paths through which air and the like are circulated.

Next, descriptions of the power generating mechanism of the power generating section 40 of the fuel cell unit 10 will be made along flows of fuel and air (oxygen).

First, the high-concentration methanol in the fuel cartridge 43 is flowed into the mixing tank 45 by the fuel supply pump 44. Within the mixing tank 45, the high-concentration methanol is mixed with recovered water and low-concentration methanol (the residual part of a power generating reaction) from the fuel electrodes 47, and is diluted, resulting in low-concentration methanol being produced. The concentration of the low-concentration methanol is controlled so that a concentration (e.g., 3 to 6 mass percent) allowing the implementation of high power generation efficiency can be maintained. This control is realized by, for example, controlling, based on information from a concentration sensor 60, the amount of high-concentration methanol to be supplied to the mixing tank 45 by the fuel supply pump 44. Alternatively, this control can be implemented by pump-controlling the amount of water refluxed to the mixing tank 45, by the water recovery pump 56 or the like.

The methanol/water solution diluted in the mixing tank 45 is pressurized by the fluid feed pump 46, and injected into the fuel electrodes (negative electrodes) 47 of the DMFC stack 42. In each of the fuel electrodes 47, an oxidation reaction of methanol occurs, resulting in electrons being produced. Hydrogen ions (H⁺) generated in the oxidation reaction pass through the DMFC stack 42 and arrive at each of the air electrodes (positive electrodes) 52.

On the other hand, carbon dioxide produced by the oxidation reaction occurring in each of the fuel electrodes 47 is refluxed to the mixing pump 45 together with the methanol/water solution unused in the reaction. After having been vaporized in the mixing tank 45, the carbon dioxide heads toward the condenser 53 through the mixing tank valve 48, and is ultimately discharged from an exhaust port 58 through the exhaust valve 57.

Meanwhile, the flow of air (oxygen) is taken in from an intake port 49, and after having been pressurized by the air feed pump 50, it is injected into the air electrodes (positive electrodes) 52 through the air feed valve 51. In each of the air electrodes 52, a reduction reaction of oxygen (O₂) progresses, so that water (H₂O) is produced as water vapor, from electrons (e⁻) from an external load, hydrogen ions (H⁺) from the fuel electrodes 47, and oxygen (O₂) from the air electrodes. This water vapor is discharged from the air electrodes 52 and enters the condenser 53. In the condenser 53, the water vapor is cooled by the cooling fan 54 from vapor phase to liquid phase (water), and temporarily accumulated in the water recovery tank 55. This recovered water is supplied to the mixing tank 45 by the water recovery pump 56. Thus, a dilution circulation system 62 for diluting high-concentration methanol is implemented.

As is evident from the power generation mechanism of the fuel cell unit 10 by this dilution circulation system 62, in order to start power generation with the DMFC stack 42, it is necessary to drive the auxiliary sections 63, such as pumps 44, 46, 50, and 56; and valves 48, 51, and 57; or cooling fan 54. Thereby, a methanol/water solution and air (oxygen) are injected into the DMFC stack 42, and an electrochemical reaction progresses there, thereby providing electric power. Conversely, in order to stop power generation, the driving of these auxiliary sections 63 is stopped.

The pumps 44, 46, 50, and 56; and valves 48, 51, and 57 in the fuel cell unit 10 are arranged in a plurality of locations in the power generator 40, and constitute the dilution circulation system 62. Therefore, appropriate drive control with respect to the auxiliary sections 63 based on mutual matching thereamong is particularly important not only at the startup and stop of the power generation, but also when, for example, load variations in the information processing apparatus 18 occur or an emergency arises during the process of power generation. The control with respect these auxiliary sections 63 is performed by the fuel cell controller 41 of the fuel cell unit 10.

The refresh processing for maintaining the power generation capability is also performed by the fuel cell controller 41 controlling these auxiliary sections 63.

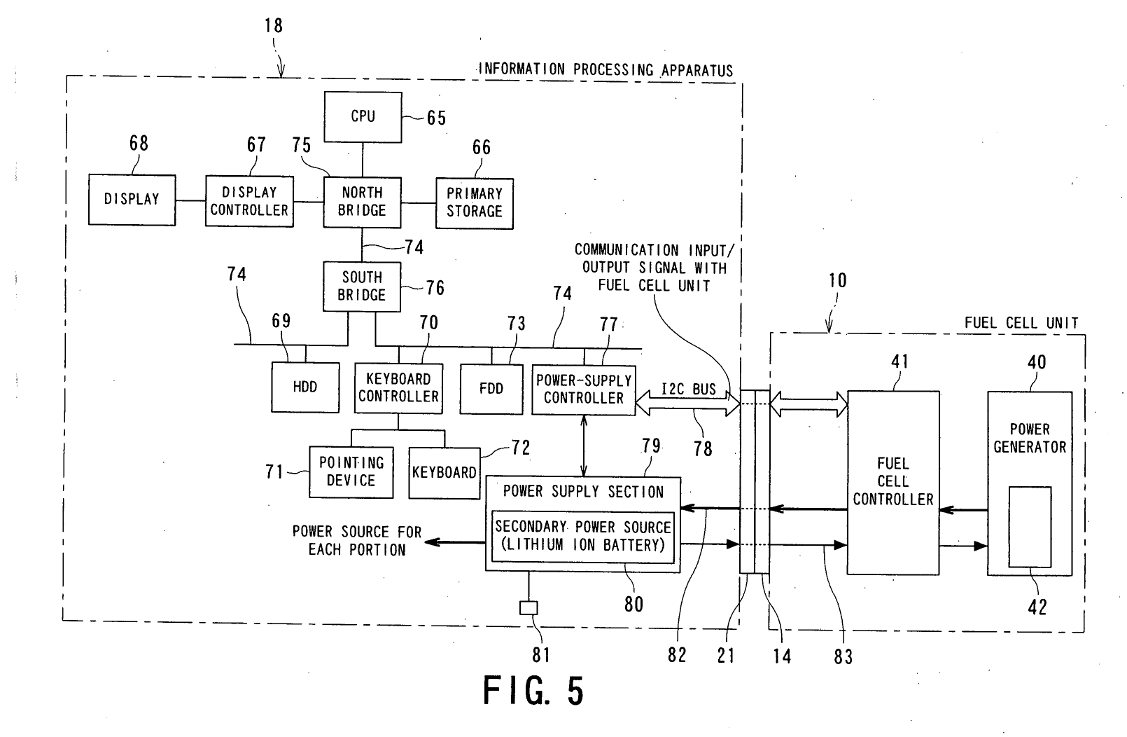

Accordingly, operations of the fuel cell controller 41 will be described in detail with reference to FIGS. 5 to 11.

FIG. 5 shows the system of the information processing apparatus 18 as an example of an information processing apparatus that is capable of communicating with the fuel cell controller 41 disposed on the fuel cell unit 10 side. The information processing apparatus 18 comprises a CPU 65, primary memory 66, display controller 67, display 68, hard disk drive (HDD) 69, keyboard controller 70, pointing device 71, keyboard 72, floppy® disk drive (FDD) 73, bus 74 for transmitting signals between the above-described constituent components, and so-called north bridge 75 and south bridge 76 each serving as a device for converting signals transmitted through the bus 74. Also, the information processing apparatus 18 has therein a power-supply unit 79, which holds, for example, a lithium-ion battery as a secondary battery 80. The power-supply unit 79 is controlled by a power-supply controller 77 of the information processing apparatus 18.

As electric interfaces between the fuel cell unit 10 and the information processing apparatus 18, there are provided a control system interface and a power-supply system interface.

The control system interface is an interface provided for performing communications between the power-supply controller 77 of the information processing apparatus 18 and the fuel cell controller 41 of the fuel cell unit 10. Communications between the information processing apparatus 18 and the fuel cell unit 10 through the control system interface is performed through, for example, a serial bus such as I2C bus 78.

The power-supply system interface is an interface provided for exchanging power between the fuel cell unit 10 and the information processing apparatus 18. For example, power generated by the DMFC stack 42 in the power generator 40 is supplied to the information processing apparatus 18 through the fuel cell controller 41 and the docking connectors 14 and 21 (power supply line 82). The power-supply system interface has also power supply lines 83 provided from the power-supply unit 79 of the information processing apparatus 18 to the auxiliary sections 63 and the like in the fuel cell unit 10.

The fuel cell units 10 may be different in the number of the supplied power supply lines 83 depending upon their types.

A direct-current power-supply that has been subjected to AC/DC conversion is supplied to the power-supply unit 79 of the information processing apparatus 18 through a connector 81 for AC adapter, thereby allowing the information processing apparatus 18 to operate and enabling the secondary battery (lithium-ion battery) 80 to be charged.

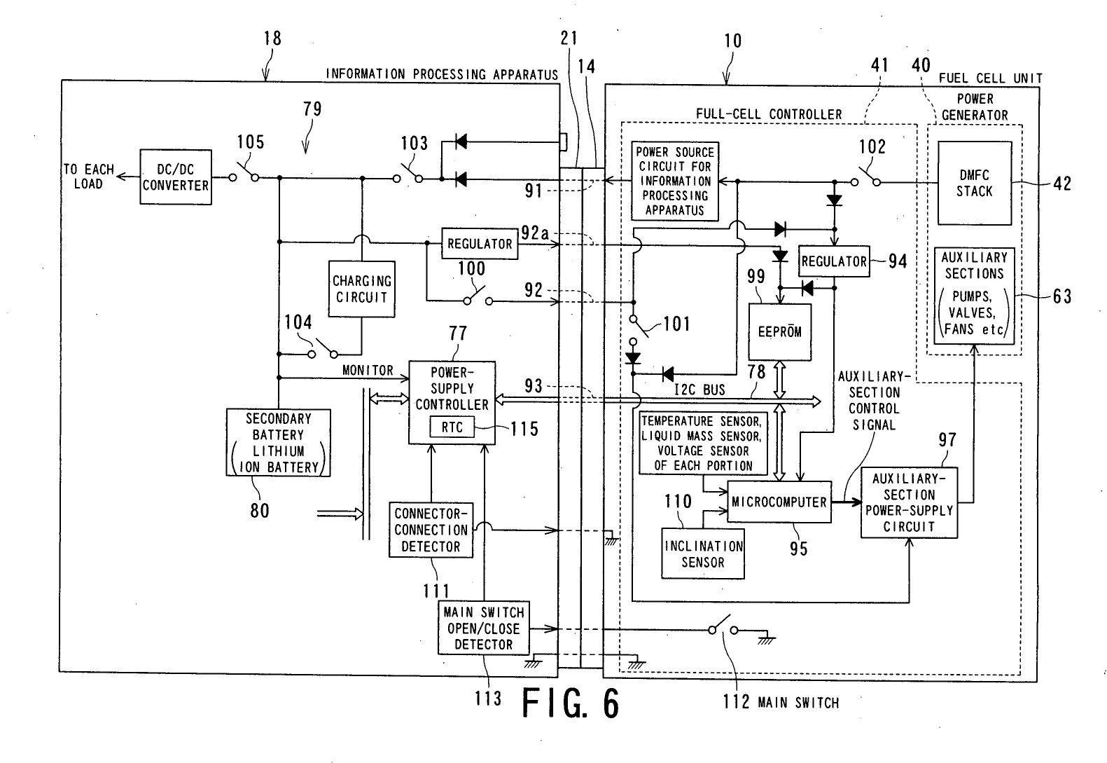

FIG. 6 is a construction example showing the electrical connection relationship between the fuel cell controller 41 of the fuel cell unit 10 and the power-supply unit 79 of the information processing apparatus 18.

The fuel cell unit 10 and the information processing apparatus 18 are mechanically and electrically connected with each other by the docking connectors 14 and 21. The docking connectors 14 and 21 includes a first power-supply terminal (i.e., output power-supply terminal) 91 for supplying power generated by the DMFC stack 42 in the fuel cell unit 10 to the information processing apparatus 18; and a second power-supply terminal (i.e., input power-supply terminal for auxiliary sections) 92 for supplying a power-supply to a microcomputer 95 in the fuel cell unit 10 through a regulator 94, and supplying a power-supply to a power-supply circuit 97 for auxiliary sections via a switch 101. Also, they have a third power-supply terminal 92a for supplying a power-supply from the information processing apparatus 18 to a nonvolatile memory (EEPROM) 99.

In addition, the docking connectors 14 and 21 have an input/output terminal 93 for communications for performing communications between the power-supply controller 77 of the information processing apparatus 18 and the microcomputer 95 in the fuel cell unit 10, and preferably for performing communications between the power-supply controller 77 and the writable nonvolatile memory (EEPROM) 99.

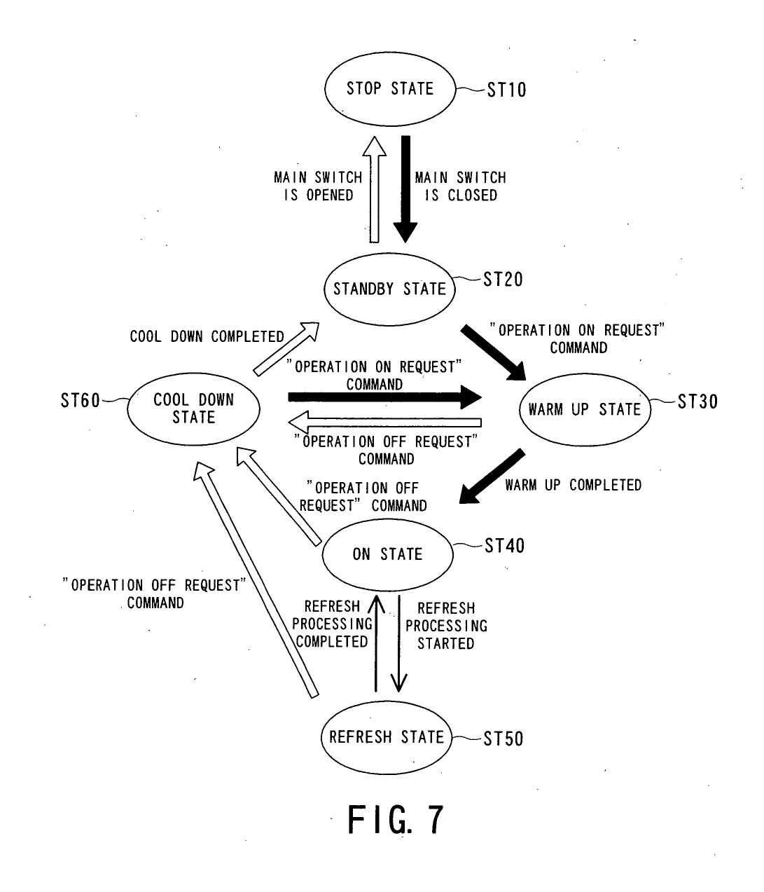

Next, using the schematic diagram shown in FIG. 6 and a state transition diagram of the fuel cell unit 10 shown in FIG. 7, descriptions will be made of the flow of processing carried out until power generated by the DMFC stack 42 in the fuel cell unit 10 is supplied to the information processing apparatus 18.

Here, it is assumed that the secondary battery (lithium-ion battery) 80 in the information processing apparatus 18 is in a state of being charged with predetermined power, and that all of the switches shown in FIG. 6 are open.

First, based on a signal from a connector-connection detector 111, the power-supply controller 77 of the information processing apparatus 18 recognizes that the information processing apparatus 18 and the fuel cell unit 10 have been mechanically and electrically connected with each other through the docking connectors 14 and 21.

Once the information processing apparatus 18 and the fuel cell unit 10 have been mechanically connected with each other through the docking connectors 14 and 21, power is supplied from the information processing apparatus 18 side to the nonvolatile memory (EEPROM) 99 in the fuel cell controller 41 through the third power-supply terminal 92a. In this EEPROM 99, identification information and the like on the fuel cell unit 10 is stored in advance. The identification information may include information such as component codes, production serial numbers, and rated outputs of the fuel cell unit 10. The EEPROM 99 is connected to a serial bus such as I2C bus 78, and data stored in the EEPROM 99 is readable in a state where the EEPROM 99 is being supplied with a power-supply. With the arrangement shown in FIG. 6, it is possible for the power-supply controller 77 to read information of the EEPROM 99 through the input/output terminal 93 for communications.

This state is one in which the fuel cell unit 10 has not yet generated power and no power-supply is being supplied to the inside of the fuel cell unit 10 except for the power-supply for the EEPROM 99. This state corresponds to a “stop state” ST10 in the state transition diagram in FIG. 7.

In this “stop state” ST10, once a main switch 112 provided in, for example, the fuel cell unit 10 has been closed, this state transits to a “standby state” ST20 shown in FIG. 7. The main switch 110 is arranged, for example, so that the user can open/close it, one example thereof being a slide type switch.

Upon closing of the main switch 112, the power-supply controller 77 of the information processing apparatus 18 recognizes that the main switch 112 has been closed, based on a signal from a main switch open/close detector 113 of the information processing apparatus 18. Then, the power-supply controller 77 reads the identification information on the fuel cell unit 10 stored in the EEPROM 99 in the fuel cell unit 10, through the I2C bus 78. Once the power-supply controller 77 has determined from the read identification information that the connected fuel cell unit 10 is a fuel cell unit matching with the information processing apparatus 18, the power-supply controller 77 closes a switch 100.

Upon closing of the switch 100, power of the secondary battery 80 in the information processing apparatus 18 is supplied to the microcomputer 95 in the fuel cell controller 41 through the second power-supply terminal 92. This state is referred to as a “standby state” ST20. In this stage, a power-supply is not yet supplied to the power-supply circuit 97 for auxiliary sections, and hence the auxiliary sections 63 have not yet come into action.

However, the microcomputer 95 is in action, and in a state of being capable of receiving various control commands from the power-supply controller 77 of the information processing apparatus 18 through the I2C bus 78. Also, in a reverse manner, the microcomputer 95 is in a state of being capable of transmitting power-supply information on the fuel cell unit 10 to the information processing apparatus 18 likewise through the I2C bus 78.

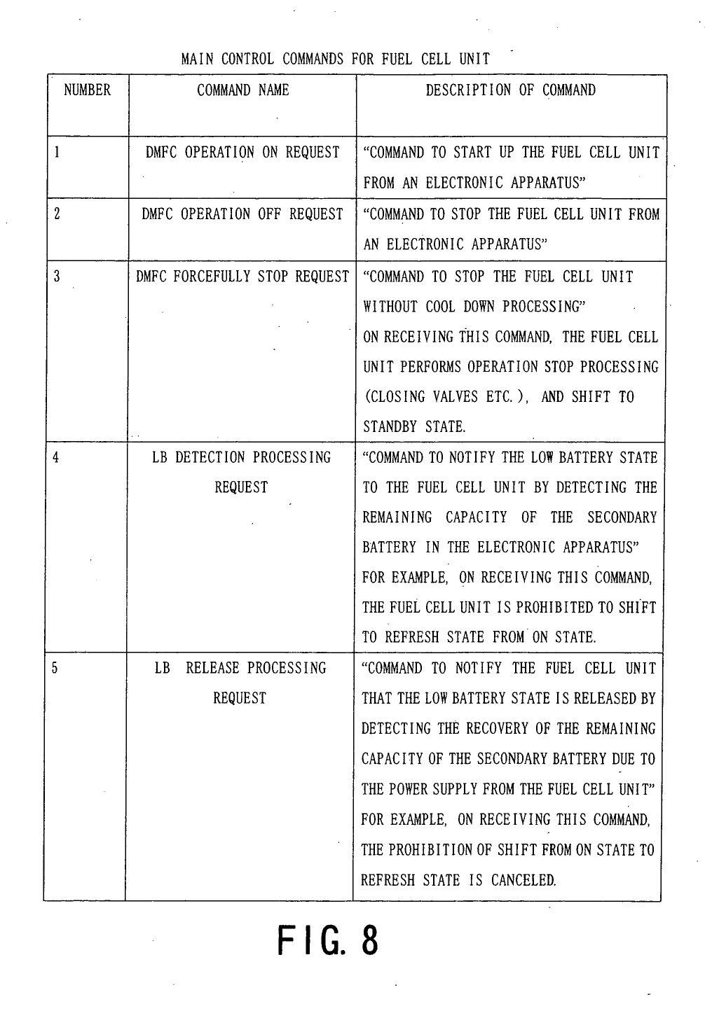

FIG. 8 shows an example of a control command sent from the power-supply controller 77 of the information processing apparatus 18 to the microcomputer 95 in the fuel cell controller 41.

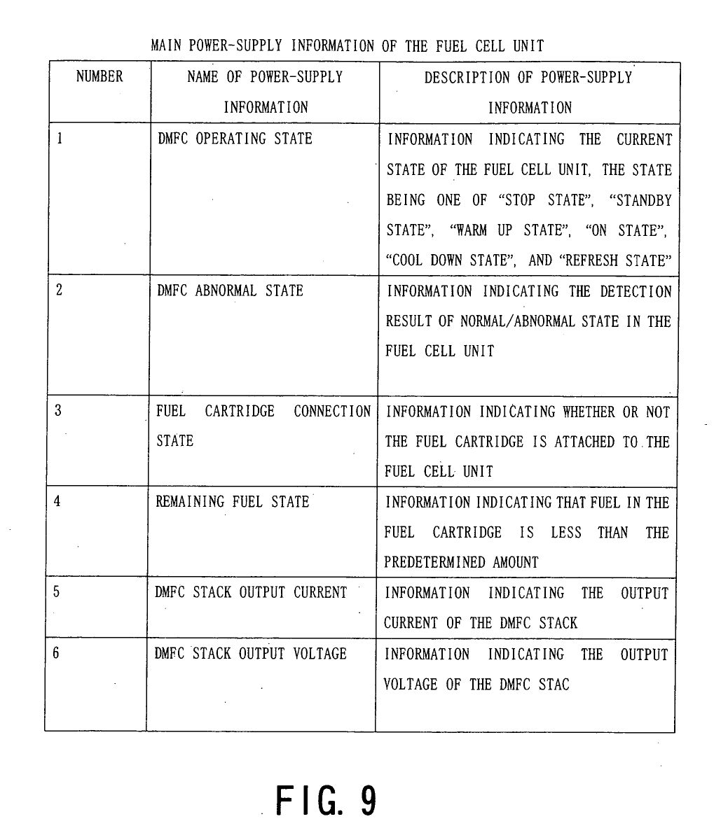

On the other hand, FIG. 9 shows an example of main power-supply information sent from the microcomputer 95 in the fuel cell controller 41 to the power-supply controller 77 of the information processing apparatus 18.

The power-supply controller 77 of the information processing apparatus 18 can recognize that the fuel cell unit 10 is in a “standby state” ST20, by reading “DMFC operating state” out of the power-supply information shown in FIG. 9.

In this “standby state” ST20, when the power-supply controller 77 sends to the fuel cell controller 41 a “DMFC operation ON request” command out of control commands shown in FIG. 8, the fuel cell controller 41, upon receipt of this command, causes the state of the fuel cell unit 10 to transit to a “warm-up state” ST30 (see FIG. 7).

Specifically, the microcomputer 95 controls the switch 101 in the fuel cell controller 41 to close, thereby supplying the power-supply circuit 97 for auxiliary sections with a power-supply from information processing apparatus 18. Furthermore, using control signals, the microcomputer 95 drives the auxiliary sections 63 in the power generator 40, that is, the pumps 44, 46, 50, and 56; the valves 48, 51, and 57; the cooling fan 54 and the like shown in FIG. 4. In addition, the microcomputer 95 closes the switch 102 in the fuel cell controller 41.

As a result, in the fuel cell unit 10, methanol/water solution and air are injected into the DMFC stack 42 in the power generator 40, thus starting power generation. The power generated by the DMFC starts to be supplied to the information processing apparatus 18. However, because the power generation output does not instantly arrive at a rated value, the state up to the arrival of the power generation output at the rated value is referred to as a “warm-up state” ST30.

Once the microcomputer 95 in the fuel cell controller 41 has determined that the output of the DMFC stack 42 has arrived at the rated value, by monitoring, for example, the output voltage and the temperature of the DMFC stack 42, it opens the switch 101, and switches the power supply source to the auxiliary sections 63 from the information processing apparatus 18 to the DMFC stack 42. This state is an “ON state” ST40 (See FIG. 7).

The foregoing is a short summary of the state transition from the “stop state” ST10 to the “ON state” ST40.

When the state of the fuel cell unit 10 enters an “ON state” ST40, the power-supply controller 77 of the information processing apparatus 18 closes switches 103 and 105 shown in FIG. 6. As a result, power from the fuel cell unit 10 can be supplied to each load inside the information processing apparatus 18 after having been converted into a predetermined voltage by DC/DC conversion. When there is a surplus of generated power, the switch 104 in the information processing apparatus 18 may be closed to charge the secondary battery 80.

Next, explanations of the refresh processing and a refresh state ST50 will now be provided.

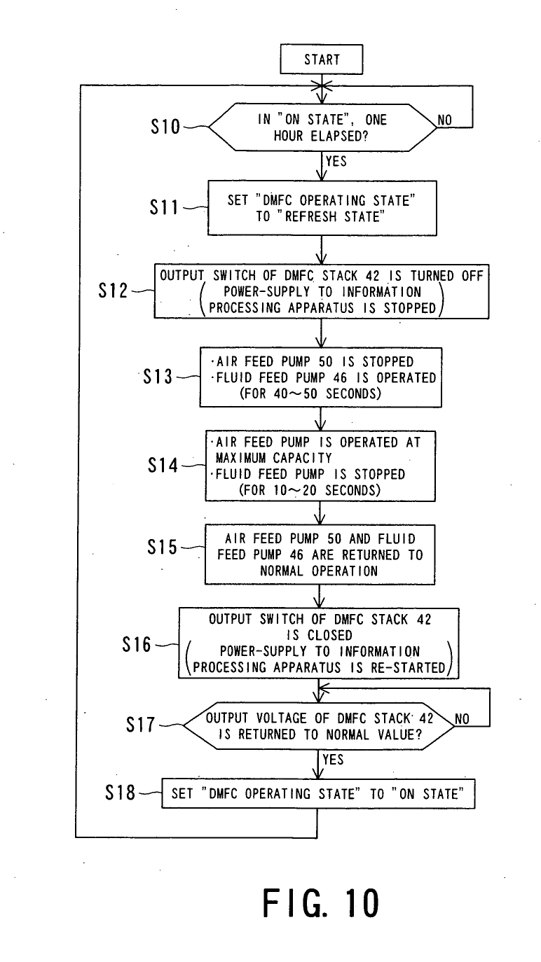

During the process of power generation, there occurs a phenomenon that bubbles of carbon dioxide adhering to the fuel electrodes 47 and water drops adhering to the air electrodes 52 reduce the power generation capability. The “refresh processing” is a processing operation for recovering this reduced power generation capability. Possible methods for the refresh processing include various types. Here, typical embodiments thereof are explained with reference to the flowchart in FIG. 10, the schematic diagram in FIG. 6 and the state transition diagram in FIG. 7.

The reduction in power generation capability occurs in the process of generating power, and the state requiring the refresh processing is a “ON state” ST40.

One possible method for making determination of the transfer to the refresh processing is a method wherein the power-supply controller 77 of the information processing apparatus 18 monitors “DMFC stack output voltage” out of power-supply information shown in FIG. 9, and wherein, when the numeral value of the output voltage becomes below a predetermined value, the power-supply controller 77 displays it on the display 68 in the information processing apparatus 18 to urge the user to perform the transfer to the refresh processing. This method, however, burdens the user with a transfer operation.

Such being the situation, it is desirable that the fuel cell controller 41 autonomously perform refresh processing. To perform autonomous refresh processing, it is necessary to autonomously make determination of the transfer to the refresh processing or of the termination of refresh processing. Possible methods therefor include:

(1) a method wherein the microcomputer 95 in the fuel cell controller 41 monitors the output voltage of the DMFC stack 42, wherein, once the output voltage has become below a predetermined value, the microcomputer 95 automatically transfers the state of the fuel cell unit 10 to a “refresh state” ST50 to start refresh processing, and wherein, once the DMFC stack voltage has recovered to a predetermined value or more, the microcomputer 95 terminates the refresh processing to returns the state of the fuel cell unit 10 to an “ON state” ST40;

(2) a method wherein, once an “ON state” ST40 has continued for a predetermined time period, the microcomputer 95 automatically transfers the state of the fuel cell unit 10 to a “refresh state” ST50 to perform refresh processing for a predetermined time period that has been separately determined, and wherein, after this time period has elapsed, the microcomputer 95 automatically terminates the refresh processing to returns the state of the fuel cell unit 10 to an “ON state” ST40; and

(3) a combined method of the above-described methods (1) and (2).

FIG. 10 explains an embodiment in which refresh processing is performed at predetermined intervals, according to the above item (2) out of the above items (1) to (3).

First, the duration of the “ON state” ST40 is counted, and it is determined whether this duration has elapsed a predetermined time period, for example, one hour (S10). If it is determined that one hour has been elapsed, that is, the determination in step S10 is “yes”, “DMFC operating state” (No. 1 out of the power-supply information shown in FIG. 9) is set to a “refresh state” (S11), and the switch 101 for allowing the power supply from the information processing apparatus 18 to the auxiliary sections 63 is closed. In addition, the output switch 102 of the DMFC stack 42 is turned off (S12). As a result, the power supply from the fuel cell unit 10 to the information processing apparatus 18 is shut off, and also the power supply to the auxiliary sections 63 and the microcomputer 95 is performed from only the information processing apparatus 18 side through the second power-supply terminal 92.

Next, the air feed pump 50 is stopped, and the fluid feed pump 46 alone is operated. This operating state of the pump is continued for e.g., 40 to 50 sec (S13). This step S13 allows bubbles of carbon dioxide adhering to liquid feed paths within the fuel electrodes 47 to be discharged and removed.

Then, the fluid feed pump 46 is stopped, and the air feed pump 50 is operated at the maximum capacity. This operating state of the pump is continued for e.g., 10 to 20 sec (S14). This step S14 allows water drops adhering to air feed paths within the air electrodes 52 to be likewise discharged and removed.

Thereafter, the fluid feed pump 46 and the air feed pump 50 are returned to the normal operating state (S15), and the output switch 102 of the DMFC stack 42 is closed (S16). The microcomputer 95 waits for the output voltage of the DMFC stack 42 to return to the normal value (S17), and if it determines that the output voltage of the DMFC stack 42 is normal (i.e., the determination in S17 is “yes”), it closes the switch 101 for allowing power from the DMFC stack 42 to the auxiliary sections 63 to be supplied, and thereby sets “DMFC operating state” (No. 1 out of the power-supply information shown in FIG. 9) to “ON state” (S18). This allows the output of the DMFC stack 42 to be supplied to the information processing apparatus 18, and also, to the auxiliary sections 63 and the like within the fuel cell unit 10.

Repeating the above-described flow enables autonomous refresh processing to be accomplished.

While the first embodiment of the fuel cell unit having the refresh state according to the present invention has been described, other embodiments are also possible.

In the first embodiment, at “refresh state” ST50, the output of the DMFC stack 42 is completely shut down. The purpose for this is to eliminate the occurrence of new bubbles and water drops in the fuel electrodes 47 and air electrodes 52, thereby making the refresh processing efficient. Namely, the first embodiment is an embodiment that places a higher priority on the refresh processing of the fuel cell unit 10 than on the power supply to the information processing apparatus 18.

Also, in the first embodiment, the power-supply for the auxiliary sections 63 during the process of the refresh processing is arranged to be supplied from the secondary battery 80 in the information processing apparatus 18. This is because many information processing apparatus 18, such as notebook personal computers, each originally have a secondary battery incorporated therein, and effective utilization of this secondary battery allows the miniaturization and weight reduction of the fuel cell unit 10.

Some information processing apparatus 18, however, do not have a secondary battery incorporated therein. In this case, an embodiment is naturally possible in which a secondary battery is incorporated into the fuel cell unit 10, and in which the power-supply for the auxiliary sections 63 during refresh processing is supplied by power from the incorporated secondary battery. This second embodiment eliminates the need for power supply from the information processing apparatus 18 through the second power-supply terminal 92 (see FIG. 6) during refresh processing.

Moreover, in the first embodiment, because autonomous refresh processing is possible, refresh processing can be performed out of the user's sight, thereby increasing the convenience for the user.

On the other hand, as shown in the power-supply information in FIG. 9 and the flowchart in FIG. 10, during refresh processing, a “refresh state” is returned to the information processing apparatus 18 as power-supply information. By this power-supply information, at least during refresh processing, the information processing apparatus side can aware the user of that effect, as required.

Next, references will be made to refresh processing at the time when the remaining amount of the secondary battery 80 in the information processing apparatus 18 has decreased below a specified value, that is, the secondary battery 80 is in a low battery (referred to as “LB” hereinafter) state.

Many information processing apparatus 18 that are operated by the secondary battery 80 make detection/determination of the low remaining amount (LB) state of the secondary battery 80. The “low remaining amount (LB)” state is regarded as a kind of abnormal state of the power-supply of the information processing apparatus 18, and referred to as a “state where the remaining amount of the secondary battery 80 incorporated in the information processing apparatus 18 is not more than a predetermined value.

The detection/determination of the low remaining amount of the secondary battery 80 is not based upon the assumption that the information processing apparatus 18 is connected with the fuel cell unit 10, but is a concept that can consist even in a conventional information processing apparatus having only a secondary battery (lithium-ion battery). Once the secondary battery in the information processing apparatus 18 has been determined to be in a low remaining amount (LB) state, for example, measures to start a termination sequence of an application program may be taken after having taken measures to store data in the course of processing. Taking such measures in advance allows the avoidance of an occurrence of the abnormal termination of the application program and disappearance of data and the like due to a sudden power outage as a result of exhausting the remaining amount of the secondary battery.

In the first embodiment of the fuel cell unit 10, during refresh processing, the auxiliary sections 63 are each supplied with a power-supply from the secondary battery 80 in information processing apparatus 18. Therefore, in the event that power of the secondary battery 80 in information processing apparatus 18 suddenly goes off during the refresh processing, this causes a detrimental effect on the fuel cell unit 10.

While the fuel cell unit 10 is generating power in a steady state, that is, in an “ON state” ST40, the auxiliary sections 63 are each supplied with power generated by the fuel cell unit 10. Also, in the “ON state” ST40, out of the auxiliary sections 63, e.g., the air feed valve 51 for taking in air from the outside; and the mixing tank valve 48 and the exhaust valve 57 for discharging air to the outside are in open states. In a “refresh state” ST50 also, these valves are in open state, as well. Therefore, in a “refresh state” ST50, in the event that power of the secondary battery 80 in the information processing apparatus 18 goes off, these valves are left open, thereby causing an intrusion of impurities from the outside. This results in a reduction in the reliability of the fuel cell unit 10.

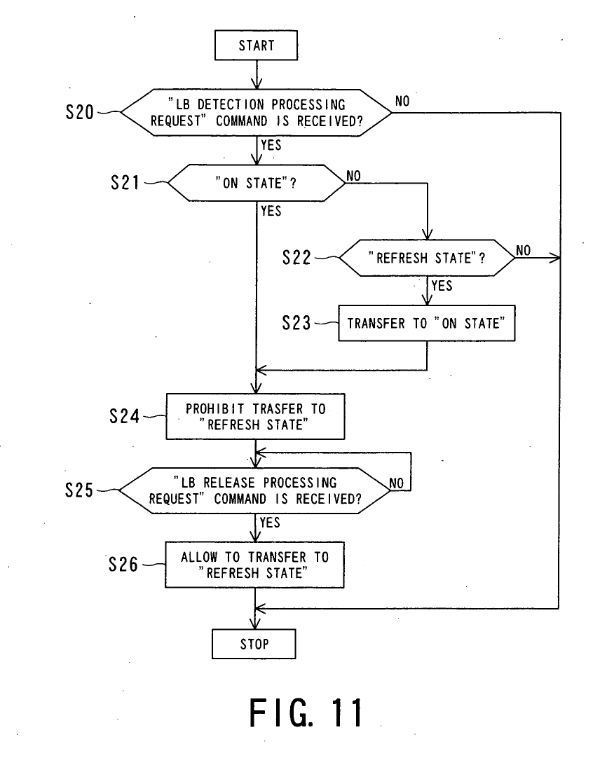

With this being the situation, measures to avoid the above-described detrimental effect by using information on low remaining amount (LB) of the secondary battery 80 in the information processing apparatus 18 are implemented as a third embodiment of the present invention. This third embodiment is described using a flowchart shown in FIG. 11.

First, the microcomputer 95 in the fuel cell controller 41 determines whether a control command sent from the information processing apparatus 18 through the input/output terminal 93 for communications contains a “LB detection processing request” command (S20). Upon receipt of the “LB detection processing request” command, the microcomputer 95 further determines the state of the fuel cell unit 10 (S21). If the fuel cell unit 10 is in an “ON state” ST40, the microcomputer 95 prohibits the transfer of the state of the fuel cell unit 10 to a “refresh state” ST50 (S24). On the other hand, if the fuel cell unit 10 is in a “refresh state” ST50, the microcomputer 95 forcibly transfers the state of the fuel cell unit 10 to an “ON state” ST40 (23).

The processing shown in the flowchart shown in FIG. 11 always keeps the fuel cell unit 10 in an “ON state” ST40 when the secondary battery 80 is in a low remaining amount (LB) state. In the “ON state” ST40, power for the auxiliary sections 63 are supplied from the DMFC stack 42. Therefore, even if the power-supply of the secondary battery 80 that would otherwise be supplied from the information processing apparatus 18 goes off, the auxiliary sections 63 are not affected, thereby avoiding a detrimental effect.

In an “ON state” ST40, power generated by the DMFC stack 42 is supplied to the information processing apparatus 18 through the first power-supply terminal 91, thereby allowing the secondary battery 80 to be charged. When the remaining amount of the secondary battery 80 recovers a value above a predetermined value by this charge, the information processing apparatus 18a transmits a “LB release processing request” command. Upon receipt of this command (S25), the microcomputer 95 in the fuel cell controller 41 permits the transfer to a “refresh state (S26). As a result, the fuel cell unit 10 returns to a state allowing autonomous refresh processing that is, for example, performed at predetermined intervals.

The present invention is not limited to the above-described embodiments, but may be embodied by modifying its components in its implementation stage without departing its true spirit and scope. Also, various inventive aspects can be implemented by appropriately combining a plurality of components disclosed in the above-described embodiments. For example, some components may be eliminated from all components used in an embodiment. Moreover, components across different embodiments may be combined as appropriate.

What is claimed is:

1. A fuel cell unit comprising:
a connection portion used for establishing the connection with an external apparatus;
a fuel cell for generating power to be supplied to the external apparatus via the connection portion;
auxiliary sections for feeding air and fuel to the fuel cell; and
a controller for controlling the auxiliary sections and performing refresh processing to improve power generation efficiency of the power generator.

2. The fuel cell unit according to claim 1, wherein the controller performs refresh processing at predetermined intervals.

3. The fuel cell unit according to claim 1, wherein the controller performs refresh processing when an output voltage of the fuel cell decrease below a predetermined value.

4. The fuel cell unit according to claim 1, wherein, during the refresh processing, the controller stops the power supply from the power generator to the external apparatus through the connection portion.

5. The fuel cell unit according to claim 1, wherein, during the refresh processing, the controller receives power from the external apparatus through the connection portion.

6. The fuel cell unit according to claim 1,
wherein,
the auxiliary sections includes an air feed pump for feeding the air to the fuel cell and an fluid feed pump for feeding the fuel to the fuel cell, and
the controller halts the air feed pump for a predetermined time while driving the fluid feed pump.

7. The fuel cell unit according to claim 1, wherein the controller communicates with the external apparatus through the connection portion.

8. The fuel cell unit according to claim 7, wherein the controller answers whether it is in the process of performing the refresh processing, in response to a command for reading power-supply information on the fuel cell unit, the command being issued from the external apparatus and received by the controller through the connection portion.

9. The fuel cell unit according to claim 7,
wherein,
when the controller receives, through the connection portion, a command indicating that the external apparatus is in the abnormal condition, prohibits to perform the refresh processing,
when the controller receives, through the connection portion, a command indicating that the external apparatus has recovered from the abnormal condition, permits to perform the refresh processing.

10. An information processing apparatus, comprising:
a fuel cell unit including a fuel cell and a controller for performing refresh processing to improve efficiency of power generation caused by the fuel cell;
a connection portion connected to the fuel cell unit;
a power-supply unit for supplying power to the fuel cell unit through the connection portion; and
a power-supply controller for controlling the power supply from the power-supply unit to the fuel cell unit.

11. The information processing apparatus according to claim 10, wherein, during the refresh processing, the power-supply controller supplies power supplied from the power-supply unit to the fuel cell unit through the connection portion.

12. The information processing apparatus according to claim 10,
wherein,
the power-supply controller controls communication with the controller, and transmits a command for reading power-supply information to the fuel cell unit and receives power-supply information as to whether the fuel cell unit is in the process of performing the refresh processing.

13. The information processing apparatus according to claim 10,
wherein,
when the power-supply unit is in an abnormal condition, the power-supply controller transmits, through the connection portion, a command indicating that the power-supply unit is in the abnormal condition, and wherein, when the power-supply unit has been recovered from the abnormal condition, the power-supply controller transmits, through the connection portion, a command indicating that the power-supply unit has been recovered from the abnormal condition.

14. The information processing apparatus according to claim 10,
wherein, the fuel cell unit is detachable with the connection portion.

15. A method for controlling a fuel cell unit that is connectable to an external apparatus, and that includes a fuel cell, a controller for control power generation by the fuel cell, an air feed pump for feeding air to the fuel cell and a fluid feed pump for feeding fuel to the fuel cell, the method comprising the step of performing refresh processing:
wherein,
the step of performing the refresh processing includes the steps of:
halting the air feed pump for a predetermined time; and
driving the fluid feed pump for the predetermined time.

16. The method for controlling the fuel cell unit according to claim 15,
wherein,
the step of performing the refresh processing includes the step of:
stopping power supply generated by the fuel cell to the external apparatus during the refresh processing.

17. The method for controlling the fuel cell unit according to claim 15,
wherein,
the controller receives power supply from the external apparatus during the refresh processing.

18. The method for controlling the fuel cell unit according to claim 15,
wherein, the refresh processing is performed at predetermined intervals.

19. The method for controlling the fuel cell unit according to claim 15,
wherein,
the controller answers whether it is in the process of performing the refresh processing, in response to a command for reading power-supply information on the fuel cell unit, the command being issued from the external apparatus and received by the controller.

20. The method for controlling the fuel cell unit according to claim 15,
wherein,
when the controller receives a command indicating that the external apparatus is in the abnormal condition from the external apparatus, prohibits to perform the refresh processing, and
when the controller receives a command indicating that the external apparatus has recovered from the abnormal condition, permits to perform the refresh processing.
